(19) United States
(12) Patent Application Publication
(10) Pub. No.: US 2012/0231657 A1
(43) Pub. Date: Sep. 13, 2012

(54) Electrical Receptacle Enclosure

(76) Inventors: Roy Bouse, Port Bolivar, TX (US); Lucas Bouse, Port Bolivar, TX (US)

(21) Appl. No.: 13/477,537

(22) Filed: May 22, 2012

Related U.S. Application Data
(63) Continuation-in-part of application No. 13/097,018, filed on Apr. 28, 2011.
(60) Provisional application No. 61/328,662, filed on Apr. 28, 2010.

(51) Int. Cl. H01R 13/60

(52) U.S. Cl. 439/535

(57) ABSTRACT

Disclosed is an improved electrical receptacle enclosure assembly adapted increase flexibility with respect to its installation procedures, its installed location and supported electrical fixtures therein. The assembly comprises a structurally supported lower box, a middle box adapted to fit within the interior of the lower box, and an upper cover adapted to flushly mount against a mounting surface over the lower and middle boxes. The lower box includes structural mounting points, conduit knockout plates and an open upper and lower portion. The middle box comprises a lower box insert having fixture mounting points and a securing shelf adapted to connect to the lower box upper portion. Electrical fixtures are secured within the middle box and are electrically connected therebelow and covered by a fixture faceplate within the middle box. An upper cover connects the assembly together and rests against a mounting surface for a clean, flush outer appearance.

### CROSS REFERENCE TO RELATED APPLICATION

This application is a Continuation in Part of U.S. patent application No. 13/097,018 filed on Apr. 28, 2011, entitled “Floor Plug Electrical Box,” now pending, which claims the benefit of U.S. Provisional Application No. 61/328,662, entitled “Bouse Floor Plug” and filed on Apr. 28, 2010. Each patent application identified above is incorporated here by reference in its entirety to provide continuity of disclosure.

### BACKGROUND OF THE INVENTION

1. Field of the Invention

The present invention relates to electrical box devices. More specifically, the present invention pertains to an improved electrical box assembly that provides flexibility and improved installation ease for electricians and installers, wherein the box location, type of installed electrical fixtures and the steps for installing the assembly are improved over existing electrical box structures. The exterior of the assembly is designed to flushly install against its installed surface, thereby providing an effective means of electrical outlet access having an outward decorative appearance and an installation procedure that offers improved ease.

Electrical floor outlet boxes are structures adapted to retain electrical fixtures within a floor or wall surface and provide a clean exterior appearance. These devices are generally installed in a raised floor in order to achieve access to electrical wiring and account for the size of the box. Installations of this kind include receptacles for retaining electrical power devices within walls, floors and ceilings in order to provide a safe electrical housing. Most common electrical boxes are made to standard sizes and shapes, formed as single or multiple-gang boxes for respectively housing one or more electrical devices. Electrical boxes may be covered with a plate, which further encloses and insulates the electrical device, while also providing a finished decorative appearance.

Installation of typical floor electric receptacle boxes is generally at or slightly above floor level. Cords plugged into these outlets must lay sprawled out on the floor or frequently jut upwards from the receptacle box, as there is no means of containment. Additionally, such receptacle boxes often have lids, which flip up or are removed to accommodate cords. Unfortunately, improperly or hastily inserted cords may result in receptacle box lid displacement in an unsightly or hazardous manner. For example, access doors may be open or ajar due to cabling and wiring passing through an in-floor fitting. Passersby can easily trip over the cords or receptacle box lids and sustain injury. On an aesthetic level, these traditional receptacle boxes are unappealing and unsightly, and not suited for placement in visible areas. Furthermore, many consumers do not like the look of cords and plugs exposed in the middle of meticulously decorated spaces. An effective solution for the everyday consumer is necessary.

The present invention is flush mount electrical receptacle box designed to provide electrical outlets where needed, without the creation of safety hazards or interference with the surrounding decor. The present invention allows for the placement of electrical outlets below the surface of the floor with a receptacle box mounted flush with the planar surface of the floor. Use of the present invention allows items such as lamps, stereos, televisions, and other electrical items to operate in any location without unsightly outlets or hazardous cords. Installation of the present invention may be in any space where electronics are required, allowing easy concealment with decorative rugs, paneling or furniture, even in the middle of open spaces. Further, the present invention secures electrical cords in place and retains them under the floor where consumers cannot trip over them accidentally. The present invention is ideal for use in homes, businesses, offices, and other similar venues.

The present electrical box is installable into a number of different surfaces within a home, including within concrete or household flooring, along an upstanding wall, or further mounted from the ceiling. The primary advantage of the present invention is not only its outward flush-mount appearance and inset space for loose cords, but more specifically the installation methods associated with the elements of the box. The construction of the assembly allows the box to be structurally secured using a lower box, which includes structural mounting points and conduit knockouts to secure the box into place and to run necessary wiring to the desired fixtures. The middle box secures the fixtures, which are then connected to the wiring within the lower box and lowered thereinto. Finally, the upper lid covering is placed over the assembly, wherein the middle box is inserted into the lower box, whereafter fasteners are driven through all three components to secure all elements together. In this way, the installation is separated into the three primary steps using specific elements for each step: structural securement, fixture wiring and then lid installation.

2. Description of the Prior Art

Patents have been granted to several devices that attempt to improve the ease of installation of electrical floor boxes, and further to those emphasizing concealment and safety of electrical receptacles. However, the prior art fails to provide a device having a construction and assembly of components similar to the present invention, which improves the steps of installation and separates them into specific elements for each step.

Specifically, U.S. Pat. No. 4,536,612 to Domigan discloses an electrical floor box for raised floors, comprising a hollow main housing and a means of separating the housing into two power sections. The housing mounts wire connectors for each power section, while a passageway allows power connector to connect receptacles to the power sections. The separated power sections allow high and low voltage receptacles to be placed within the same box. While providing a unique receptacle box capable of separating power sources, the Domigan device is limited to raised floors wherein access behind the main housing is required for securement thereof to the floor. The present invention is capable of mounting in a number of different flooring or wall types, including those where access behind the wall or floor is not possible. The lower box of the present invention is capable securing to wall studs, floor supports or be secured by external footings in concrete floors. The Domigan further is limited to being anchored into a wood flooring and not anchored into concrete, and further requires its internal electrical fixture to face inwards, limiting plug cord access over a vertical design. The present invention provides a separating divider between high and low voltage lines without sacrificing ergonomics of plugging in cords.

U.S. Pat. No. 7,989,711 to Jolly discloses a floor box that is particularly suited for ultra shallow floor installations. The installation comprises a body having a base and perimeter side wall, and a cover having a cover body and cover lid. The side wall is adapted to be raised above the floor level, while the cover is provided to close off the base and cover the raised portion of the perimeter sidewall. The fixtures of the Jolly device are adapted to rest in a vertical orientation along the upstanding perimeter sidewall of the installation, wherein single gang outlets are installed for electrical plug connection. While this provides a device for shallow floor environments, the Jolly device does not disclose the novel installation elements and flexibility with which the device may be installed or the flexibility with respect to the chosen fixtures therein.

U.S. Pat. No. 6,878,877 and U.S. Published Patent Application Publication 2005/0167141 to Cozzi disclose an electrical outlet box assembly having an outlet box, an electrical fixture assembly and an adapter. The adapter is located between the box and the electrical fixture, wherein the height of the adapter may be adjusted relative to the outlet box to adjust for different floor or wall covering material thicknesses. This adjustment of the adapter allows the outlet box to be positioned well below floor level, while the electrical fixture assembly may be raised to floor level and cover by a face plate for a flush outward appearance. While the adapter provides a means to support a fixture within a larger box that is secured within the floor, the purpose and design of the Cozzi device diverges in intent and design from the present invention, which discloses a middle box within a secure lower box and the middle box is adapted to secure electrical fixtures within the interior of the assembly and then be covered by a lid structure for access. It is not desired to position the fixture at floor level, but rather to disclose an accessible floor box having an open interior that allows access for a plurality of different electrical plugs for access to power or electrical signals.

The Cozzi devices is also limited in the fact that it cannot be installed into a cement floor, but rather only into a wood floor due to the flanges connecting the outlet box and the electrical fixture on the top of the assembly. An attached plug into the electrical fixture makes connection at floor level, which does not allow for the ability to hide a length of cord within the outlet box interior, creating a trip hazard and unsightly run of excess cord. Further, once the outlet box of Cozzi is installed, you cannot remove it from the floor because it is mounted onto the sub floor and not the finished floor. This is inconvenient when you need to install a box after the finished top flooring is in place, as the lid will flushly mount to the flooring surface as the outlet box cannot be mounted below the finished flooring, and the stages of the box will not sandwich the finished flooring between the insert and the outlet box. This elevates the assembly and the cover plate above the floor surface, which is not desirable.

Other examples of prior art are directed to office and commercial applications. In particular they are intended to be hooked to both electrical and communications lines, as well as installed within a concrete slab with metal conduit. Bowman U.S. Pat. No. 5,467,565 is directed to a method and apparatus for activation of services in a concrete floor of an office building from below floor slab distribution systems. Void-forming boxes that are secured to a conventional metal deck sheet and surrounded by the concrete floor slab provide chambers in which in-floor electrical fixtures are mounted. Connection hardware is secured to the metal deck sheet for connection to a conventional below-floor slab service distribution system providing communication from the interior of the box to the below-floor slab service distribution system. Similarly, Young U.S. Pat. No. 5,796,037 is directed to an electrical floor box providing connections to one or more in-floor service distribution systems. The Young invention includes lower and upper portions defining a hollow interior and a plurality of wiring compartments and conduction tunnels interconnecting the wiring compartments.

In a similar manner, Bowman U.S. Pat. No. 7,183,503 is directed to an in-floor fitting for providing access to an underfloor electric distribution system. The in-floor fitting includes a cover configured to move between open and closed positions and being moved to an open position to allow a cable to pass therethrough. The in-floor fitting includes a receptacle positioned below the cover and configured to operatively connect to a cable comprising at least one of an electrical cable and a communication cable, wherein the cover is substantially flush with a surface of a floor when the cable is operatively connected to the receptacle and the cover is in the closed position.

The foregoing Bowman and Young prior art devices are directed toward office based applications of electrical boxes. As such, applications of these utilitarian inventions will not be desirable in a home or office in which both aesthetics and functionality are a concern. It is unlikely that home use will necessitate or even allow the installation of such commercial boxes. Rather, homeowners will desire electrical boxes such as the present invention, which may interface with standard home electrical systems and be aesthetically appropriate and more suited to residential applications.

Markiewicz U.S. Pat. No. 5,866,845 is directed to an electrical box in which an enclosure is provided that includes a base, sides and at least one yoke for receiving an electrical device. The box enclosure can be formed of discrete components, which can be assembled to form a single or multiple-gang box. The Markiewicz invention is an adaptation of a traditional electrical receptacle or switch box, intended to allow the practitioner to use multiple attached boxes in a side-by-side manner. Further, Markiewicz is designed to address the issue of fluid access to the electrical device. The invention described in Markiewicz fails to address the issues of floor mounted electrical box installation, concealment and safety, and further does not address the ability to mount in different flooring or wall locations using the same assembly.

Other prior art is directed toward concealing receptacles when not in use. Riedy U.S. Pat. No. 6,265,662 is directed to an apparatus for use with an electrical receptacle and a floor box. A first part of the apparatus defines a floor plate, which is configured to fit over the floor box in an installed position. The floor plate has an inner edge surface defining an access opening for providing access to the receptacle. A second part of the apparatus defines an access door for closing the access opening. The invention described in Riedy functions to obscure and protect electrical or communications outlets when not in use. During use, the door on the surface of the receptacle box must remain open, resulting in an unsightly and potentially dangerous issue, thereby limiting the receptacle to temporary usage. The present invention addresses the issue by allowing the receptacle box lid to remain closed at all times and providing a small opening from which the cords may extend outward.

The present invention is adapted to provide an assembly that is not limited by the structure of the surface being installed thereinto, including wood and cement flooring, overhead installations wherein mounting is accomplished from below or above, and finally wall mounting. The elements of the lower box provides flexibility with regard to its installed medium, while the middle box and cover provide improved electrical wiring steps and a means to conceal the fixture and extra cords within the cavity of the installation. The present invention will greatly assist users with electrical appliance and device management by allowing the placement of electrical receptacles in any location in a safe and aesthetically pleasing manner. It is therefore submitted that the present invention is substantially divergent in design elements from the prior art, and consequently it is clear that there is a need in the art for an improvement to existing electrical receptacle enclosures. In this regard the instant invention substantially fulfills these needs.

### SUMMARY OF THE INVENTION

In view of the foregoing disadvantages inherent in the known types of electrical receptacle enclosures now present in the prior art, the present invention provides a new receptacle box wherein the same can be utilized for providing a convenient device for the user for improving the versatility of a single box with regard to efficient installation of electrical outlets and improved safety with regard to cord and outlet concealment.

It is therefore an object of the present invention to provide a new and improved electrical receptacle enclosure device that has all of the advantages of the prior art and none of the disadvantages.

It is another object of the present invention to provide an electrical receptacle enclosure that offers improved flexibility with respect to the type of surface being installed into, increasing the number of applications for the same assembly.

Another object of the present invention is to provide an electrical receptacle enclosure that includes an assembly and construction that facilitates easier installation, wherein the segmented elements of the enclosure are secured together in a way that allows assembly from below the floor, above the floor and through finished and unfinished flooring surfaces.

Still another object of the present invention is to provide an electrical receptacle enclosure that may be secured within a concrete floor via a plurality of tab footers, within an unfinished floor, wall or ceiling or into an already finished interior surface.

Yet another object of the present invention is to provide an electrical receptacle enclosure that includes an interior cavity to store excessive electrical cord lengths, reducing trip hazards and reducing clutter within an interior space.

A final object of the present invention is to provide an electrical receptacle enclosure that conforms to commercial and residential electrical codes, while offering the same flexibility with respect to its location and steps for installation.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is an exploded perspective view of the present invention showing a two-gang electrical fixture installation.

FIG. 2 is an exploded perspective view of the middle box insert, electrical fixtures and wiring divider plate.

FIG. 3 is an overhead perspective view of the present invention in an open and installed configuration.

### DETAILED DESCRIPTION OF THE INVENTION

Reference is made herein to the attached drawings. Like reference numerals are used throughout the drawings to depict like or similar elements of the electrical receptacle enclosure. For the purposes of presenting a brief and clear description of the present invention, the preferred embodiment will be discussed as used for providing an improved construction for ease of installation and greater flexibility with regard to installation. The figures are intended for representative purposes only and should not be considered to be limiting in any respect.

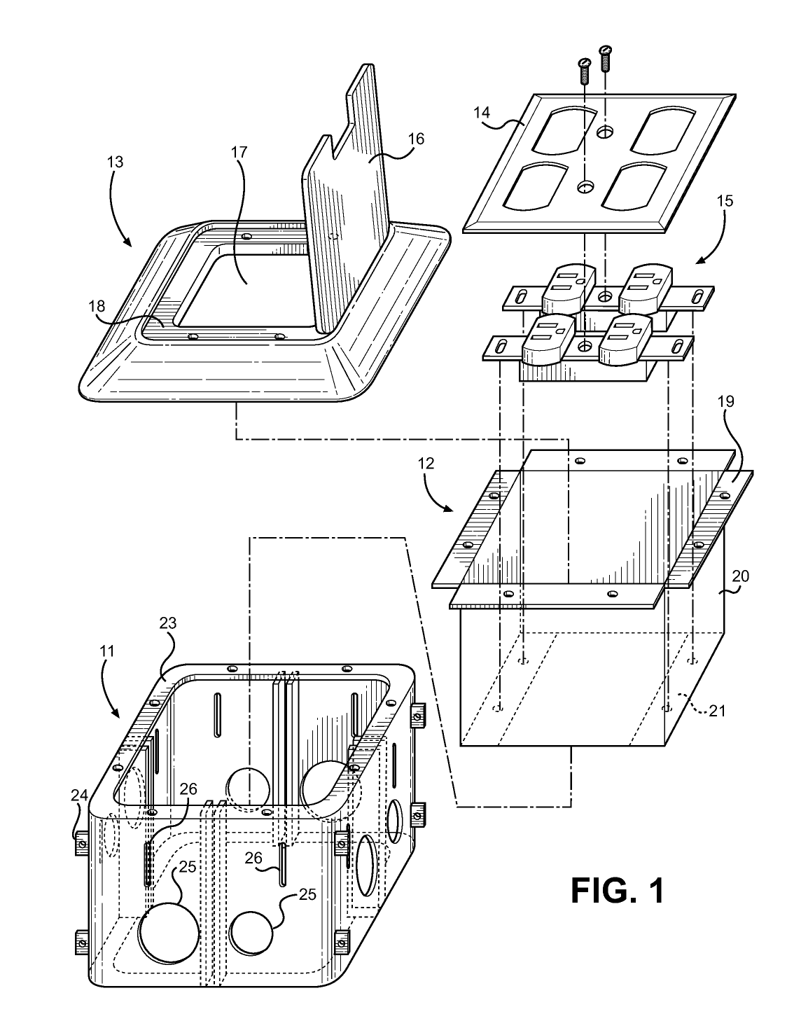

Referring now to FIG. 1, there is shown an exploded perspective view of the electrical receptacle enclosure of the present invention. The assembly comprises three main elements that form the structure of the enclosure and allow the assembly to be installed in several different surface types. The assembly is secured to one or more structural ground supports using a lower box 11, which comprises a hollow enclosure having an open upper and lower and enclosed sidewalls. Along the sidewalls are mounting tabs 24 and mounting rails 26 which act as structural mounting points for the assembly. The lower box 11 is adapted to be installed into a cut-out or hole within a subfloor, finished floor, concrete floor, ceiling or similar indoor surface from overhead or beneath the mounting surface, wherein the box 11 is secured to floor beams, wall studs, the finished floor or secured via poured concrete. Within the walls of the lower box 11 are conduit apertures 25 having knockout plates, wherein the apertures 25 are adapted to accept electrical wiring therethrough. The interior of the lower box 11 includes two sets of opposed rails 22, which act as supports for a divider plate that is utilized to separate the incoming wiring for building code purposes. Finally, the upper region of the box comprises a ledge, shelf or surface 23 that is adapted to support the remaining elements of the assembly via a plurality of common fasteners inserted therethrough.

Within the lower box 11 and positioned thereover is a middle box insert 12, which comprises an electrical fixture support and shroud that obscures the underlying wiring within the assembly. The geometry of the middle box 12 adapted to fit within the lower box 11 between the lower box rails 22 and above an installed divider plate therebelow. The middle box 12 is adapted to be utilized as a support for the installed electrical receptacles and fixtures, and allow a user to make necessary wiring connections thereto via connection to incoming wiring through the lower box 11. The middle box provides support ledges 21 for electrical fixtures to secure thereto prior to be spliced into the underlying lower box 11 wiring after the lower box 11 has been inserted into a desired location and secured to an appropriate support structure. The middle box 12 comprises upstanding sidewalls 20 that fit within the geometry of the lower box hollow interior 11, wherein the sidewalls 20 shroud the wiring connections from a user accessing the assembly for connection of an electrical cord to an installed outlet fixture. The sidewalls 20 form the structure of the middle box 12, wherein its interior is hollow and its upper and lower regions are open to allow access thereinto. Along the upper portion of the middle box 12 is a support ledge 19, which is adapted to rest against the upper surface 23 of the lower box. Aligned apertures provide a means to join the lower box to the upper box via common fasteners, which are further utilized to secure a closure lid 13 over the entire assembly.

Within the middle box 12, it is contemplated that a number of different styles and combinations of electrical outlets and fixtures 15 may be secured thereto. The fixtures 15 may be a single or double gang outlet, or comprise varying digital signal or electrical connectivity receptacles. The fixtures 15 themselves are secured directly to the middle box lower support ledge 21, whereafter a fixture cover plate fits directly thereover and is secured to the fixtures themselves. The cover plate 14 is sized to fill the base of the middle box 12 such that no opening exist which may provide access or visualization of underlying wire connections. The cover plate 14 may be a continuous structure, or alternatively one that includes separated cover plates connected to a common plate that is sized for the interior of the middle box 12.

Positioned over the installed lower box 11, the middle box 12 and its spliced electrical fixtures 15 is an enclosure cover lid 13. The lid 13 secures to the assembly via a plurality of common fasteners that align through the upper surface 23 of the lower box, the upper support ledge 19 of the middle box and the interior ledge 18 of the lid. The lid 13 comprises a open interior 17 adapted to provide access to the fixtures 15 therebelow, along with a lid flap 16 that allows the interior of the assembly to be closed. The lid 16 further comprises a notch that is adapted to allow electrical cords to fit therethrough, wherein excess cord is placed within the interior of the assembly (middle box interior) and the cord or cords are routed through the notch in the lid. This permits the lid to be closed and still allow electrical connection of the cords to the fixtures 15. The design of the lid cover 13 is one that is adapted to be relatively parallel and not overly raised above its installed surface, wherein the base of the cover 13 rests against the surface and the lid 16 and the thickness of the overall cover 13 is minimized. The ability to store excess cord length and the low thickness cover reduces trip hazards and improves outward aesthetics of the assembly once installed and in use.

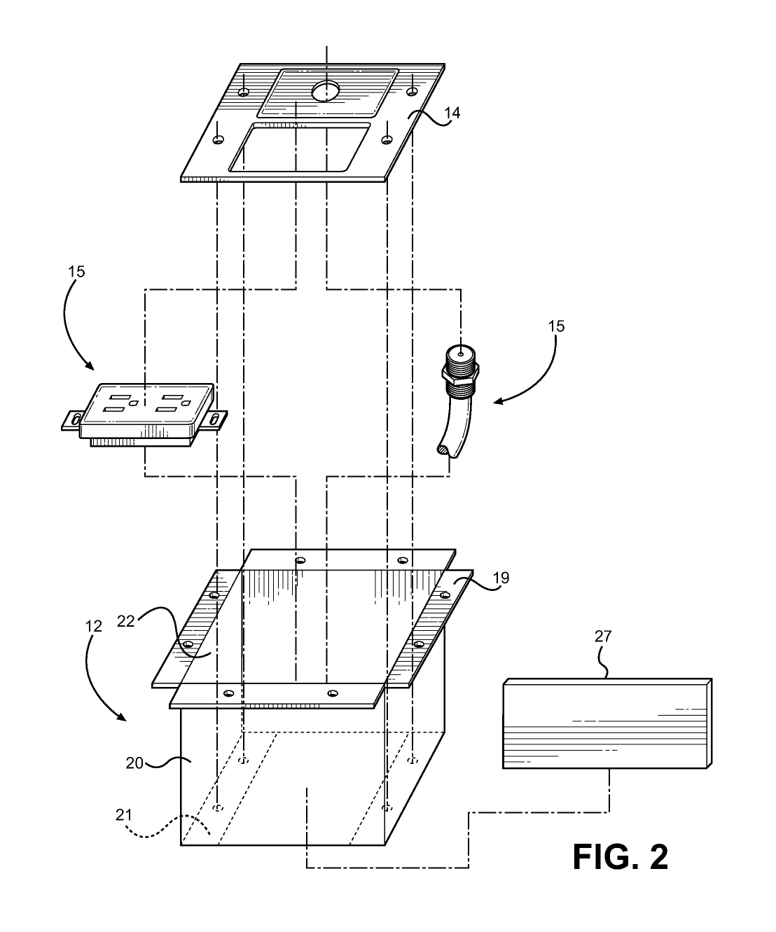

Referring now to FIG. 2, there is shown an exploded perspective view of the middle box 12 and an alternate set of installed fixtures 15 therein. The middle box insert 12 is adapted to provide a support frame for the fixtures 15, which fasten directly to a lower support ledge 21 along the interior base of the box 12, whereafter a cover plate 14 having apertures adapted to accept the installed fixtures 15 is secured thereover. The entire open base of the middle box 12 is shrouded by the cover plate 14 such that through access below the fixtures 15 is not possible. The fixtures 15 themselves may comprise NC power fixtures for 110V or 220V electrical connectivity, coaxial cable, telephone connectors or any other electrical or signal source that may be desired to be placed within the enclosure for access thereto. Below the middle box 12 may further be positioned a divider plate 27, which is adapted to separate wiring of different types below the fixtures 12 and within the lower box 11.

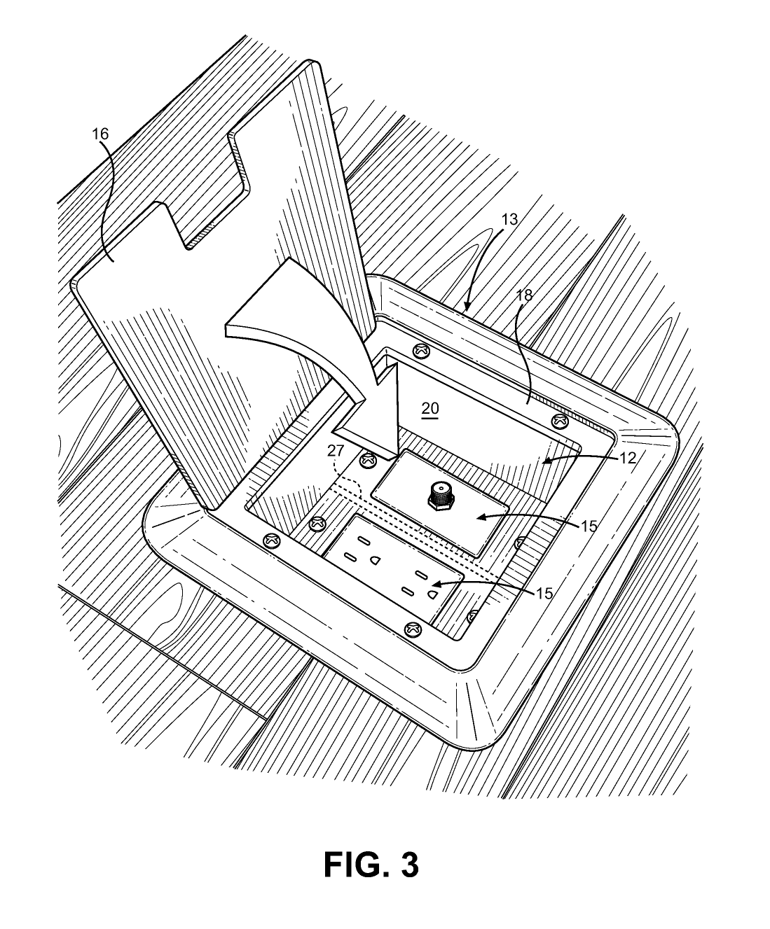

Referring now to FIG. 3, there is shown an overhead view of the present invention in an open and installed state, wherein the assembly is secured within a finished floor. When installed, the cover 13 provides a relatively flush mount electrical floor box that is recessed within the floor or desired surface. The lid 16 provides access to the internal cavity established by the middle box sidewalls 20, the fixtures 15 and the fixture cover plate. Fasteners through apertures along the interior ledge 18 of the cover 13 secure the entire assembly together, and further allowing the assembly to be easily disassembled and rewired for different fixtures if desired.

The present invention provides a user with the ability to install different fixtures within the interior of the box, and increase the ease of installation over currently available floor box structures. The box is not limited to the structure of the floor being installed into, as it can be mounted from underneath a wood structure by cutting out an appropriate aperture to fit the bottom box and using the tabs on the side to mount to the nearest stud. The tabs can also be used to secure the bottom box into concrete. The box can also be installed from the top by simply removing the tabs, sliding into the correctly measured cut out, and securing with screws from the inside of the box to the outside nearest stud. This is advantageous because this assembly can also be installed after top floors have been set and are not limited to installation during the building process. If the depth of the floor is not deep enough to house the bottom box, the box can be cut to meet to levels of the floor. This makes for a clean install and reduces the trip hazards. Further, it is contemplated that the geometry and size of the box may vary depending on need and user style. The lower box, middle box insert and the aperture of the cover may be rectangular, circular or any desired shape that still falls within the requirements of the middle box fitting within the lower box and common fasteners securing the assembly once aligned and wired.

Overall, the present invention is designed to increase the versatility of an electrical floor box by providing one that can be utilized in a number of different floor and wall types, and further one that provides fixtures that are easily interchangeable and removable. The structure of the box once installed further provides for both aesthetic qualities and a means to stow loose cord length from lamps and other devices connected to the box fixtures. The present invention is designed to provide electrical outlets where they are needed, without creating safety hazards or interfering with surrounding decor. This places electrical outlets below the surface of the floor or within a desired interior surface, allowing items such as lamps, stereos, televisions, and other electrical items to operate in any desired location. The invention can further be installed in any space where electronics are required, and can be easily concealed by decorative rugs or furniture. Electrical cords are held securely in place and stored under the floor where consumers cannot trip over them accidentally. It is ideal for use in homes, businesses, offices, and other similar venues.

In light of the present disclosure and its elements with regard to the prior art, it is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An electrical receptacle enclosure, comprising:
a hollow lower box having upstanding sidewalls, an open upper and lower region, an upper surface ledge, electrical conduit apertures through said sidewalls, and structural mounting points along said sidewalls;
said lower box adapted to secure to structure within an aperture along a surface;
a hollow middle box insert adapted to fit within said lower box interior, said middle box having upstanding sidewalls and an open upper and lower region, an electrical fixture support ledge inwardly projecting from said middle box lower region, and a perpendicular box support ledge protruding outward from said open upper region;
said electrical fixture support ledge having apertures adapted to accept mounting hardware for at least one electrical fixture;
said at least one electrical fixture being connected to wiring from below said middle box that is fed through said lower box electrical conduit apertures;
an electrical fixture cover plate secured over said at least one electrical fixture and securing over said middle box lower region;
a cover having a rotatable lid and an interior ledge adapted to align with said middle box upper support ledge and said lower box upper surface ledge;
said cover interior ledge, said middle box upper support ledge, and said lower box upper surface ledge secured together by common fasteners driven therethrough and into said lower box.

2) The device of claim 1, wherein said lower box further comprises a pair of aligned and upstanding divider rails along said box sidewalls, said rails adapted to accept a divider walls for creating a physical barrier between wiring beneath said fixtures and said middle box.

3) The device of claim 1, wherein said lower box structural mounting points along said sidewalls further comprises slide apertures for mounting fasteners therethrough for connection to support structure.

4) The device of claim 1, wherein said lower box structural mounting points along said sidewalls further comprises outwardly protruding tabs for mounting fasteners therethrough or for providing concrete footers for connection to support structure.

5) The device of claim 1, wherein said cover lid further comprises a notch for accepting electrical cords therethrough while allowing said lid to be in a closed position.

6) The device of claim 1, wherein said installed middle box sidewalls, fixtures, and fixture cover plate create an enclosure within which electrical plugs may be positioned and extra cord length may be stowed.
